(19) United States
(12) Patent Application Publication
(10) Pub. No.: US 2021/0339212 A1
(43) Pub. Date: Nov. 4, 2021

(54) A METHOD OF DISPERSING FINE PARTICLES IN AN AQUEOUS OR POLAR SOLVENT

(71) Applicant: Croda, Inc., Plainsboro, NJ (US)

(72) Inventors: Kapil Deshpande, Plainsboro, NJ (US); Li Chen, Plainsboro, NJ (US)

(73) Assignee: Croda, Inc., Plainsboro, NJ (US)

(21) Appl. No.: 17/286,309

(22) PCT Filed: Oct. 4, 2019
(86) PCT No.: PCT/US2019/054734

§ 371 Date: Apr. 16, 2021

Related U.S. Application Data
(60) Provisional application No. 62/752,474, filed on Oct. 30, 2018.

(51) Int. Cl. B01F 17/00; C08G 65/331; B01F 3/12; C01F 11/18; C01G 23/047

(52) U.S. Cl. CPC B01F 17/0028; C08G 65/3312; B82Y 40/00; C01F 11/185; C01G 23/047; B01F 3/1214

(57) ABSTRACT

The present invention relates to a method of dispersing fine particles in an aqueous or polar solvent. The dispersant comprises a compound of general formula (I): In general formula (I), AO is an alkylene oxide group selected from ethylene oxide and propylene oxide, R¹ is selected from a methyl group, an ethyl group, a propyl group, a butyl group, and a pentyl group, R² is a carboxylic acid terminated group comprising 1 to 5 carbon atoms between the carboxylic acid and the polyalkylene glycol group (-(AO)ₙ—O—), and n is 2 to 100. A dispersion of nanoparticles comprising the dispersant, use of the dispersant, and a method for dispersing nanoparticles is also disclosed.

### CROSS-REFERENCE TO RELATED APPLICATION

This application is related, and claims the benefit of priority of, U.S. Provisional Application No. 62/752,474, titled A METHOD OF DISPERSING FINE PARTICLES IN AN AQUEOUS OR POLAR SOLVENT, filed on 30 Oct. 2018, the contents of which is incorporated herein by reference in its entirety for all purposes.

### FIELD OF INVENTION

The present invention relates to a method of dispersing fine particles such as nanoparticles in an aqueous or polar solvent. The invention also relates to the dispersant which is a compound of general formula (I).

### BACKGROUND

Due to their size, which present unique properties and features, nanoparticles have attracted interest in various fields. However, nanoparticles have a strong tendency to aggregate in solution.

Aggregation of nanoparticles presents several challenges. One problem caused by the aggregation of nanoparticles is the loss of the unique properties resulting from the size of the nanoparticles.

Another problem caused by aggregation is increased difficulty in processing and handling the nanoparticles. Aggregation can cause an increase in the processing viscosity, as well as cause issues in the use of the nanoparticles. For example, inks containing printable silver nanoparticles can clog inkjet printing nozzles when the nanoparticles aggregate.

Nanoparticles are typically stabilized by bound ligands and then dispersed into an incompatible media with a non-adsorbing surfactant. These systems, however, require permanently binding a ligand directly to the nanoparticles, e.g. by ligand exchange and/or ligand interchelation.

Therefore, there is a need for a dispersant for fine particles, such as nanoparticles, in aqueous or polar systems that solves one or more of the problems discussed above and which may enable scalable manufacturing.

### SUMMARY OF INVENTION

The present invention relates to a dispersant that can reversibly adsorb onto the surface of a nanoparticle via a carboxylic acid terminal group while also providing steric stabilization through a polyalkylene glycol tail that is compatible with the solvent. Such reversible adsorption may be advantageous when compared with systems in which ligands are permanently bound to the nanoparticles.

Viewed from a first aspect, the present invention provides a method of dispersing nanoparticles in an aqueous or polar solvent comprising the step of using a compound of general formula (I) as a dispersant:

R¹-(AO)ₙ—O—R² (I)

wherein:

each AO is an alkyleneoxy group selected from ethyleneoxy and propyleneoxy;

R¹ is selected from a C1 to C6 alkyl group;

R² is a carboxylic acid terminated group comprising 1 to 5 carbon atoms between the terminal carboxylic acid and the polyalkylene glycol group (-(AO)ₙ—O—); and

n is 2 to 100.

Without wishing to be bound by theory, nanoparticles which are selected from metals and salts thereof, oxides, titanates, silicates, carbonates, carbides and combinations thereof may not be suitable for ligand binding. The present invention may be advantageous for such nanoparticles by providing a compound of general formula (I) as a dispersant.

Viewed from a second aspect, the present invention provides a dispersion obtainable by, preferably obtained by, a method according to the first aspect.

Viewed from a third aspect, the present invention provides the use of a dispersant as defined herein for dispersing nanoparticles in an aqueous or polar solvent.

Any aspect of the invention may include any of the features described herein with regard to that aspect of the invention or any other aspects of the invention.

### BRIEF DESCRIPTION OF DRAWINGS

FIG. 1 shows the viscosity of a solution containing barium carbonate nanoparticles in water with a dispersant according to an embodiment of the present invention.

FIG. 2 shows the viscosity of a solution containing barium carbonate and titania nanoparticles in water with a dispersant according to an embodiment of the present invention.

FIG. 3 shows a comparison of particle size distribution of titania nanoparticles in water with and without a dispersant in accordance with an embodiment of the present invention.

FIG. 4 shows a graph comparing the average particle size of titania nanoparticles in water with and without a dispersant in accordance with an embodiment of the present invention.

### DETAILED DESCRIPTION OF THE INVENTION

It will be understood that any upper or lower quantity or range limit used herein may be independently combined.

All molecular weights defined herein are number average molecular weights unless otherwise stated. Such molecular weights may be determined by gel permeation chromatography (GPC) using methods well known in the art. The GPC data may be calibrated against a series of linear polystyrene standards.

As used herein, the term “fine particle” refers to a nanoparticle, i.e., a particle having an average size of less than 1000 nm, preferably an average size of at least 1 nm and less than 1000 nm, as measured by laser diffraction. The apparatus used to measure the particle size by laser diffraction may be a Horiba-LA960. It is understood that the term “average size” refers to the average size of the longest dimension, preferably linear dimension, of the particle.

According to at least one embodiment of the present invention, the dispersant comprises a compound with a terminal carboxylic acid group and a tail comprising a polyalkylene glycol group, i.e., -(AO)ₙ—O—. The tail may be selected from, a polyethylene glycol group, i.e. —(OCH₂CH₂)ₙ—O—, a polypropylene glycol group, i.e.,

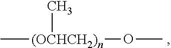

or a mixture of ethyleneoxy (EO) and propyleneoxy (PO) groups. Preferably the tail is a polyethylene glycol group.

Without wishing to be bound by theory, it is believed that the terminal carboxylic acid adsorbs onto the surface of the fine particles, thus anchoring the dispersant to the nanoparticles. The polyalkylene glycol tail is compatible with aqueous and polar solvents and provides steric stabilization to effectively disperse and stabilize the fine nanoparticles in solution.

The dispersant may be adsorbable on to the nanoparticles, preferably reversibly adsorbable to the nano-particles. Preferably the dispersant does not permanently bind to the nanoparticles. The dispersant may not chemically bond to the nanoparticles, preferably does not covalently bond to the nanoparticles. The dispersant may not form a ligand on the nanoparticles, preferably not a bound ligand. The nanoparticles may not be suitable for ligand binding.

The dispersant may comprise a compound of general formula (I):

R¹-(AO)ₙ—O—R² (I).

In at least one embodiment, each AO is an alkyleneoxy group selected from ethyleneoxy (EO) and propyleneoxy (PO), preferably each AO is ethyleneoxy (EO).

According to at least one embodiment, n is 2 to 100. Preferably, n is 5 to 50, and more preferably, n is 10 to 25.

In at least one embodiment, the polyalkylene glycol group (-(AO)ₙ—O—) has a number average molecular weight ranging from 100 to 4000, such as, for example from 250 to 2500, or from 500 to 1000. In at least one embodiment, the polyalkylene glycol has a number average molecular weight of 750, e.g., PEG 750.

In at least one embodiment, R¹ is C1 to C6 alkyl group. Preferably, R¹ is selected from a methyl group, an ethyl group, a propyl group, a butyl group, and a pentyl group, and more preferably, R¹ is a methyl group or ethyl group. In at least one embodiment, R¹ is a methyl group.

According to at least one embodiment, R² is a carboxylic acid terminated group. Preferably, R² comprises 1 to 5 carbon atoms between the carboxylic acid and the polyalkylene glycol group, i.e., -(AO)ₙ—O—.

As used herein, the phrase “1 to 5 carbon atoms between the terminal carboxylic acid and the polyalkylene glycol group” refers to the number of carbon atoms contained within the backbone between the carbon atom of the terminal carboxylic acid and the polyalkylene glycol. R² may be branched or unbranched. When R² is branched, R² may contain additional carbon atoms attached to the backbone between the carboxylic acid and the polyalkylene glycol. Preferably R² is unbranched.

R² may be substituted or unsubstituted and may be saturated or unsaturated.

R² may comprise only one carbonyl group, i.e., the carbonyl group of the terminal carboxylic acid, such as, for example, an acetic acid group. In other embodiments, R² may comprise two carbonyl groups including the carbonyl group of the terminal carboxylic acid, where R² comprises, for example, a succinate group or a maleate group.

In at least one embodiment, R² comprises only one carbonyl group, e.g., R² is

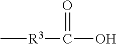

and the compound has the structure of general formula (II):

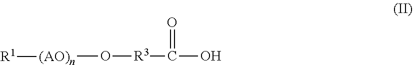

in which R¹, AO, and n are defined as above for general formula (I), and R³ is a saturated or unsaturated, branched or unbranched hydrocarbyl group such that there are 1 to 5 carbon atoms between the carboxylic acid and the polyalkylene glycol group (-(AO)ₙ—O—). Preferably R³ is unbranched.

According to at least one embodiment, R³ is a —CH₂— group, i.e., R² is an acetic acid group.

In other embodiments, R² may comprise a second carbonyl group in addition to the carbonyl group of the carboxylic acid, i.e., R² is

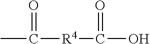

and the compound has the structure of general formula (III):

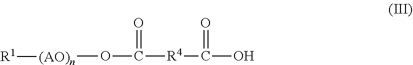

in which R¹, AO, and n are defined as above for general formula (I), and R⁴ is a saturated or unsaturated, branched or unbranched hydrocarbyl group such that there are 2 to 5 carbon atoms between the carboxylic acid and the polyalkylene glycol group (-(AO)ₙ—O—), i.e., R⁴ forms, with the carbonyl group, a backbone comprising 2 to 5 carbon atoms between the terminal carboxylic acid group and the polyalkylene glycol group. Preferably R⁴ is unbranched.

In at least one embodiment, R⁴ is a —CH₂—CH₂— group or a —CH═CH— group, i.e., R² is a succinate group or maleate group, respectively.

In accordance with at least one embodiment of the invention, a dispersion comprises a dispersant which is a compound of general formula (I), an aqueous or polar solvent, and fine particles, e.g., nanoparticles. The dispersion may be obtainable, preferably is obtained, by a method according to the invention.

The nanoparticles may not comprise a semi-conductor material. Preferably the nanoparticles do not exhibit opto-electronic properties (or do not comprise an opto-electronic material). Preferably the nanoparticles are not quantum dots.

The nanoparticles may be selected from metals and salts thereof, oxides, titanates, silicates, carbonates, carbides and combinations thereof. Preferably, the nanoparticles are selected from ceramic nanoparticles, mineral nanoparticles and elemental metal nanoparticles. The elemental metal nanoparticle may consist essentially of, preferably consists of a single metal element.

Preferably, the nanoparticles comprise at least one oxide, titanate or carbonate compound. Preferably the nanoparticles comprise an oxide. The oxide may be a metal oxide.

Preferably, the nanoparticles comprise a metal oxide. Examples of metal oxide nanoparticles include but are not limited to titania, ceria, zirconia, yttria, zinc oxide, iron oxide, copper oxide, barium oxide, and magnesium oxide.

The nanoparticles may be selected from barium carbonate, copper carbonate, barium sulfate, barium titanate and mixtures thereof. Preferably, the nanoparticles are selected from barium carbonate, titania, barium titanate and mixtures thereof.

The nanoparticles may comprise silicon carbide.

The nanoparticles may be elemental metal nanoparticles. Examples of metal nanoparticles include, but are not limited to, silver, gold, nickel, platinum, and cobalt. Preferably, the nanoparticles comprise silver nanoparticles. Silver nanoparticles are used, for example, in inkjet printable formulations using an alcohol as a solvent. Stabilizing the nanosilver particles in such formulations would help prevent the inkjet nozzles from clogging even in the presence of a faster drying solvent.

Preferably the nanoparticles comprise a titanate. Examples of titanate nanoparticles include, but are not limited to magnesium titanate, lithium titanate, and barium titanate. In at least one embodiment, the nanoparticles comprise barium titanate. Barium titanate is used, for example, in forming multi-layered ceramic capacitors where stabilization of the barium titanate nanoparticles would lower the processing viscosity and enable scalable manufacturing.

Examples of silicate nanoparticles include, but are not limited to, silicon dioxide, aluminosilicates, and borosilicates.

Examples of nanoparticles of carbides, include, but are not limited to, silicon carbide, titanium carbide, calcium carbide, and tungsten carbide.

The nanoparticles may contain a mixture of different nanoparticles or may comprise only a single type of nanoparticles. For example, the dispersion may comprise only titania, or a mixture of barium carbonate and titania.

Dispersions of these nanoparticles may be formed in a solvent selected from, for example, water, alcohol, glycol, and mixtures thereof.

According to at least one embodiment, the nanoparticles have an average size of 500 nm or less, such as, for example, less than 250 nm or less than 150 nm. In other embodiments, the nanoparticles have an average size of less than 100 nm, preferably less than 75 nm, more preferably less than 50 nm. The nanoparticles may have an average size of at least 0.1 nm, preferably at least 1 nm, more preferably at least 2 nm, particularly at least 5 nm, such as, for example, at least 10 nm, or at least 25 nm. Preferably the average size refers to the average longest linear dimension. The average size of the nanoparticles may be measured by laser diffraction.

The dispersion may be dispersed in an aqueous or polar solvent. In at least one embodiment, the solvent is water. In other embodiments, the solvent may be a polar solvent such as an alcohol, e.g. ethanol, propanol, or butanol, or a glycol, such as ethylene glycol or propylene glycol. Other polar solvents compatible with the polyalkylene glycol tail of the dispersant may also be used.

The nanoparticles may be present in the dispersion in amounts of at least 5 wt % relative to the total weight of the dispersion. In at least one embodiment, the nanoparticles may be present in the dispersion in amount of at least 10 wt %, at least 15 wt %, at least 20 wt %, at least 25 wt %, or at least 50 wt % based on the total weight of the dispersion.

The dispersant may be present in the dispersion in amounts of at least 0.1 wt % relative to the total weight of the dispersion, such as, for example, at least 0.25 wt %, at least 0.5 wt %, or at least 1 wt %. Preferably, the dispersant is present in the dispersion in amounts of 25 wt % or less, more preferably 20 wt % or less, particularly 15 wt % or less, desirably 10 wt % or less, relative to the total weight of the dispersion.

In accordance with at least one embodiment, nanoparticles, as described above, may be dispersed in an aqueous or polar solvent by adsorbing a dispersant comprising a compound of general formula (I) onto a surface of the nanoparticles.

The dispersant and nanoparticles may be agitated or mixed together in the solution. For example, aggregates can be broken up using a high pressure homogenizer or using ultrasonic dispersion.

The dispersion may be formed at room temperature (i.e., 20-25° C.) or at an elevated temperature. For example, the dispersion may be heated up to 100° C. to aid in the dispersion of the nanoparticles.

The nanoparticle dispersions may be stable for at least 1 day, preferably at least 1 week, and more preferably at least 1 month. As used herein, the term “stable” means that the dispersion remains substantially suspended in solution (i.e., no more than 10 wt % of the nanoparticles fall out of solution) and substantially non-agglomerated (i.e., the average size increases by no more than 10% of the starting size).

Any or all of the disclosed features, and/or any or all of the steps of any method or process described, may be used in any aspect of the invention.

### EXAMPLES

The invention is illustrated by the following non-limiting examples.

It will be understood that all test procedures and physical parameters described herein have been determined at atmospheric pressure and room temperature (i.e. about 20° C.), unless otherwise stated herein, or unless otherwise stated in the referenced test methods and procedures. All parts and percentages are given by weight unless otherwise stated.

### Example 1

In Example 1, a dispersion of barium carbonate was prepared in water. 50 wt % barium carbonate (Sigma Aldrich) was dispersed in water using methyl(polyethylene glycol) succinate with a number average molecular weight of 750 for the polyethylene glycol group (MPEG 750 succinate). The dispersant was loaded at a total of 0.5 wt % relative to the total weight of the dispersion.

The dispersion was made using an Ultra Turrax T-25 high-speed homogenizer run at 20,000 RPM for 30 minutes at room temperature. Measurement of the viscosity was taken the same day.

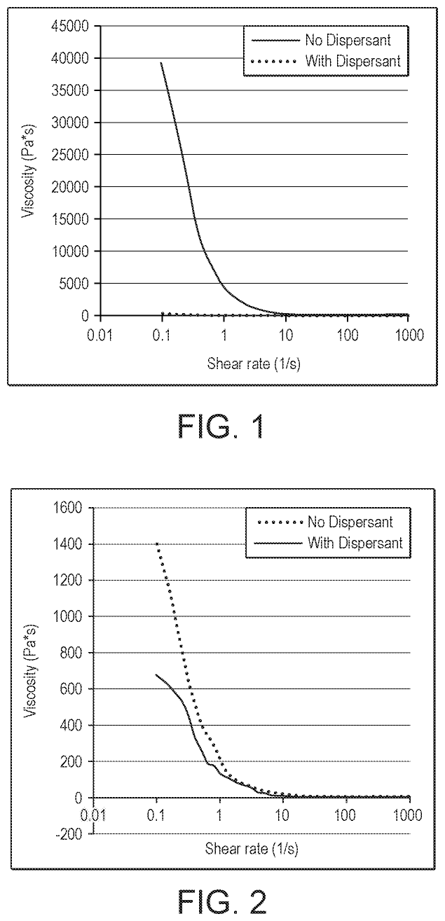

As shown in FIG. 1, the viscosity of the dispersion was significantly lower than a similar solution of 50 wt % barium carbonate in water without the dispersant.

### Example 2

In Example 2, a dispersion was prepared using a mixture of BW-KS barium carbonate nanoparticles and AMT-100 titania nanoparticles (6 nm nominal particle size) in water. 35.7 wt % barium carbonate (Sakai Chemical, grade BW-KS) was mixed with 14.3 wt % titania (Tayca, AMT-100) in water. Methyl(polyethylene glycol) succinate (MPEG 750) was loaded at 0.5 wt % relative to the total weight of the dispersion.

The dispersion was made with an Ultra Turrax T-25 high-speed homogenizer at 20000 RPM for 30 minutes at room temperature. Measurement of the viscosity was taken during the same day.

As shown in FIG. 2, the dispersant significantly reduced the viscosity of the dispersion compared to a similar solution prepared without the dispersant.

### Example 3

A dispersion of 15 nm titania (nominal size reported by manufacture [Showa Denko, F-6A) in water was prepared using MPEG 750 succinate as a dispersant. The titania was subjected to a high pressure homogenizer 3 times at 30,000 psi to break down agglomerates to approximately 100-200 nm. 5 wt % of the titania was added to water with a load of 0.25 wt % of the dispersant relative to the total weight of the composition.

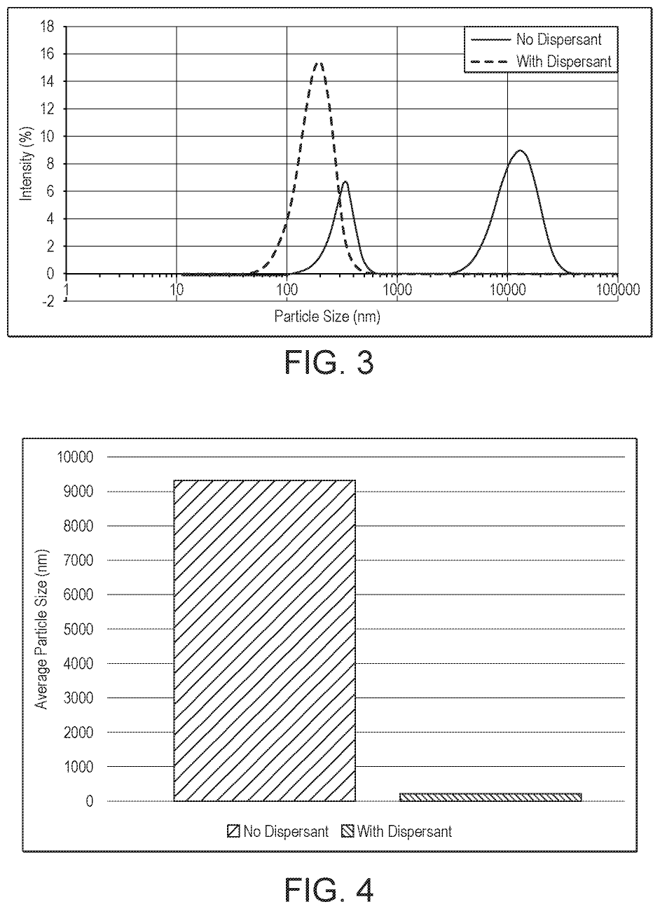

One day after preparing the dispersion, the particle size was measured and compared to a control sample which was prepared in an identical manner without the addition of the dispersant. As shown in FIG. 3, the dispersion with the dispersant exhibited a substantially monomodal size distribution. The control sample with no dispersant exhibited a bimodal size distribution.

As shown in FIG. 4, the average particle size of the dispersion prepared with the dispersant was approximately 200 nm. The control sample exhibited significant aggregation and had an average particle size of more than 9 μm. Based on these results, the dispersant prevented additional agglomeration and stabilized the dispersion.

It is to be understood that the invention is not to be limited to the details of the above embodiments, which are described by way of example only. Many variations are possible

1. A method of dispersing nanoparticles in an aqueous or polar solvent comprising the step of using a compound of general formula (I) as a dispersant:
R¹-(AO)ₙ—O—R² (I)
wherein:
each AO is an alkyleneoxy group selected from ethyleneoxy and propyleneoxy;
R¹ is selected from a C1 to C6 alkyl group;
R² is a carboxylic acid terminated group comprising 1 to 5 carbon atoms between the terminal carboxylic acid and the polyalkylene glycol group (-(AO)ₙ—O—); and
n is 2 to 100;
wherein the nanoparticles are selected from metals and salts thereof, oxides, titanates, silicates, carbonates, carbides and combinations thereof.

2. A method according to claim 1, wherein R¹ is selected from a methyl group, an ethyl group, a propyl group, a butyl group, and a pentyl group.

3. A method according to claim 1, wherein R¹ is a methyl group.

4. A method according to claim 1, wherein R² is selected from a succinate group, a maleate group, and an acetic acid group.

5. A method according to claim 1, wherein R² is 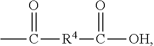
such that the compound has the structure of general formula (III): 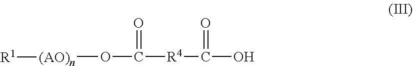
wherein R⁴ is a saturated or unsaturated, branched or unbranched hydrocarbyl group such that R⁴ forms, with the carbonyl group, a backbone comprising 2 to 5 carbon atoms between the terminal carboxylic acid and the polyalkylene glycol group (-(AO)ₙ—O—).

6. A method according to claim 1, wherein n is 5 to 50.

7. A method according to claim 1, wherein the polyalkylene glycol group (-(AO)ₙ—O—) has a number average molecular weight ranging from 500 to 1000.

8. A method according to claim 1, wherein each AO is an ethyleneoxy group.

9. A method according to claim 1, wherein the nanoparticles have an average size of less than 500 nm.

10. A method according to claim 1, wherein the nanoparticles have an average size of less than 250 nm.

11. A method according to claim 1, wherein the nanoparticles are selected from ceramic nanoparticles, mineral nanoparticles and elemental metal nanoparticles.

12. A method according to claim 1, wherein the nanoparticles comprise at least one oxide, titanate or carbonate compound.

13. A method according to claim 1, wherein the nanoparticles are selected from barium carbonate, titania, barium titanate and mixtures thereof.

14. A method according to claim 1, wherein the nanoparticles comprise silver nanoparticles.

15. A method according to claim 1, wherein the nanoparticles comprise silicon carbide.

16. A dispersion obtained by a method according to claim 1.

17. Use of a dispersant according to claim 1 for dispersing nanoparticles in an aqueous or polar solvent.
